(19) United States
(12) Patent Application Publication
(10) Pub. No.: US 2005/0175330 A1
(43) Pub. Date: Aug. 11, 2005

(54) Facial steam generator

(76) Inventor: Kazutoshi Kaizuka, Minami-ku (JP)

Correspondence Address: Squire, Sanders & Dempsey L.L.P.;14th Floor, 801 S. Figueroa Street, Los Angeles, CA, 90017-5554, US

(21) Appl. No.: 10/889,414

(22) Filed: Jul. 12, 2004

(30) Foreign Application Priority Data
Jan. 16, 2004 (JP) 2004-000160

(51) Int. Cl. A61H 33/12

(52) U.S. Cl. 392/405

(57) ABSTRACT

A steam generator provides steam for care of facial skin by incorporating negative ions and low intensity electromagnetic waves in the steam. The steam generator may incorporate a powder mixture that releases far infrared rays with the steam. The steam generator includes a water storage container, a heater for boiling water, a detachable lid on the water storage container, a steam passage from the water storage container to a steam nozzle, and a high-voltage electrical discharge unit for atomizing steam in the steam passage. A portion of the steam generator, such as the water storage container, is coated with a powder mixture that releases negative ions and far infrared rays with the steam.

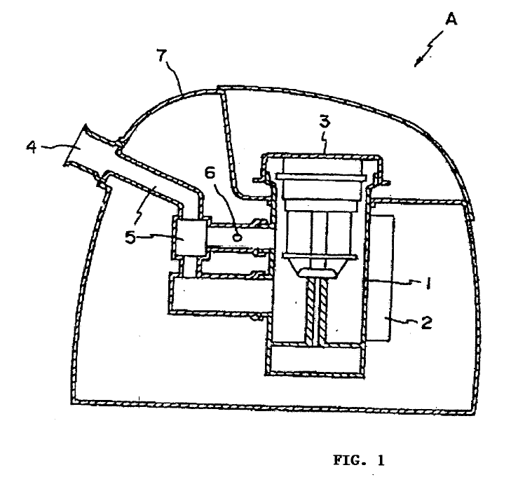

### BACKGROUND OF THE INVENTION

This application claims priority to Japanese Patent Application No. 2004- 000160, filed Jan. 16, 2004 and whose entire contents are hereby incorporated by reference.

1. Field of the Invention

This invention relates to a steam-generating device capable of beautifying facial skin and specifically relates to a steamer that produces beneficial effects to facial skin through a synergy of steam, negative ions and electromagnetic waves released from a multi-element mineral.

2. General Background and State of the Art

Japanese Patent Application Publication 2003-159305 (the “'305 publication”) discloses a steam generator used for facial applications. The steam generator includes a water storage container with a detachable lid, a heater for boiling the water in the water storage container to produce steam, a steam passage to conduct steam to a release nozzle, and a high-voltage electrical discharge unit for atomizing the steam in the steam passage. Steam released through the nozzle is applied to a user's face to care for the facial skin of the user. Water molecules in the steam penetrate the facial skin to moisturize it and give it a healthier appearance.

### SUMMARY OF THE INVENTION

There are, however, limitations to the steam generator as described in the '305 publication. First, the steam generator only uses steam to care for the facial skin. Second, the size of the water molecules in the steam varies such that many of the water molecules may be too large to penetrate the facial skin of the user to moisturize the facial skin. This invention provides a steam generator capable of providing a synergy of steam, negative ions and electromagnetic waves in order to beautify facial skin. The steam generator incorporates a multi-element mineral powder to generate steam with negative ions and electromagnetic waves for more effective care of facial skin. In addition, the steam generator may incorporate a powder of a far infrared radiating material that is mixed with the multi-element mineral powder, so that far infrared rays emitted from the powder of a far infrared radiating material can also be applied to facial skin. The steam generated through the steam generator in accordance with this invention provides more effective facial skin care through the synergy of steam, negative ions and electromagnetic waves released from mixed powders of a multi- element mineral powder and a powder of far infrared radiating material.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWING

The invention can be better understood with reference to the following figure. The components in the figure are not necessarily to scale, emphasis instead being placed upon illustrating the principles of the invention.

The FIGURE is a cross-sectional view of a steam generator in accordance with this invention.

### DETAILED DESCRIPTION OF THE PREFERRED EMBODIMENTS

Referring to the FIGURE, a steam generator A of the present invention is illustrated having a water storage container 1, a heater 2, a lid 3 detachably attached to the water storage container 1, a steam passage 5 from the water storage container 1 to a nozzle 4, and a high-voltage electrical discharge unit 6 for atomizing steam in the steam passage 5; and these items are incorporated in a body 7. The heater 2 is operated by an on/off switch (not shown), and the high-voltage electrical discharge unit 6 is controlled by a control circuit (not shown). The water storage container 1 may be coated with a powder mixture made by mixing a multi-element mineral powder and a powder of a far infrared radiating material. The powder may be formed by mixing a multi-element mineral powder and a powder of a far infrared radiating material added to heat-resistant formica, a coating agent. The formica so treated is applied to the surface of the water storage container 1, and the water storage container 1 is heated in a furnace to remove the coating agent. This way, the powder mixture may be locked on to the inner surface of the water storage container 1.

The term multi-element mineral refers to a mineral having primarily silicon such as perlite or rosin, with a remaining balance of one or multiple elements. The mineral emits low intensity electromagnetic waves which, when applied to facial skin in combination with steam, mineralize moisture and activate proteins in the facial skin.

The multi-element mineral, such as perlite, may be crushed to particles one to three microns in diameter in a ball mill or other implement to form a powder. The multi- element powder is preferably used as an appropriate blend of two or more types. First, the multi-element mineral powder can be used in an unmodified form. Second, the multi-element mineral may be combined with water, then heated or compressed, and then be freeze-dried or spray dried of the supernatant. The components of perlite, the multi-element mineral in one embodiment of the invention, are shown in the Table below.

TABLE

| | |
|---|---|
| Anhydrous silicon (SiO₂) | 71.94% |
| Aluminum oxide (Al₂O₃) | 14.94% |
| Iron oxide (Fe₂O₃) | 2.54% |
| Magnesium oxide (MgO) | 0.44% |
| Calcium oxide (CaO) | 2.47% |
| Alkaline oxides (K₂O + Na₂O) | 6.87% |
| Manganese oxide (MnO) | 0.03% |
| Anhydrous phosphoric acid | 0.14% |
| (P₂O₅) | |
| Loss on ignition | 3.43% |
| Loss on drying (at 110°) | 0.07% |
| Other, titanium | Trace |

A powder of alumina (Al2O3), titania (TiO2), ferrite (Fe2O3), chromium oxide (Cr2O3), silica (SiO2), yttria (Y2O3), magnesia (MgO), or the like can be used as the far infrared emitting material. Such powders are blended so as to emit far infrared rays of a wavelength suited to facial skin.

In steam generator A, water stored in the water storage container 1 is heated with the heater 2 to generate steam. The steam is atomized with the high-voltage electrical discharge unit 6 when passing through the steam passage 5, and the atomized steam is ejected from the nozzle 4 to release steam towards a user's face for treating the facial skin. The multi-element mineral coating of the water storage container 1 emits negative ions along with the steam released from the nozzle 4. The negative ions emitted with the steam create a clustering effect, reducing the size of groups of water molecules in the steam, which further moisturizes the facial skin. In other words, reducing the size of the water molecules promotes the penetration of the steam into the facial skin so that the facial skin is more thoroughly moisturized. In addition, the negative ions in the steam improve the circulation of the blood in the facial skin, thereby tightening the person's skin. As such, providing steam with smaller water molecules that are ionized tightens the facial skin of the user.

Clustering may be caused by low intensity electromagnetic waves, which may have a wavelength of four μm to fourteen μm, emitted by the multi-element mineral. The electromagnetic waves electrically change the periphery of atomic nuclei and cause the atoms of the water molecules to vibrate. This in turn cuts and shortens the water clusters in the steam thereby reducing the volume and increasing the specific gravity of the water molecules and making them more adherent to the cellular membranes of the facial skin. Moreover, intracellular Cₐ2⁺ and water permeation is increased, activating various cellular functions. As a result, moisture in the facial skin is mineralized and dermal proteins are activated, giving the face a healthy luster and moistness, and improving blood circulation. In addition, the far infrared rays warm the facial skin from within, so that the steam more thoroughly permeates the facial skin and blood circulation in the facial skin improves.

By coating the water storage container 1 with the powder mixture, a synergy is created between the atomized steam, the negative ions and electromagnetic waves released from the multi-element mineral, and the far infrared rays released from the far infrared radiating material which has a beneficial effect on facial skin. A variety of other areas may additionally or alternatively be coated with the powder mixture, such as the steam passage or the nozzle for steam release. In addition, the steam generator A may be configured so that steam is atomized with the high-voltage electrical discharge unit while passing through the steam passage.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

1. A steam generator comprising:
a water storage container;
a heating device adapted to heat water stored in the water storage container to generate steam;
a nozzle adapted to release steam from the water storage container;
a steam passage between the water storage container and the nozzle; and
a layer of powder mixture capable of emitting electromagnetic waves on at least one of the water storage container, the steam passage, and the nozzle.

2. The steam generator according to claim 1, where the layer of powder mixture further emits far infrared rays.

3. The steam generator according to claim 2, where the layer of powder mixture is on the water storage container.

4. The steam generator according to claim 2, where the layer of powder mixture is on the steam passage.

5. The steam generator according to claim 2, where the layer of powder mixture is on the nozzle.

6. The steam generator according to claim 2, where the powder mixture includes a mixture of alumina (Al2O3), titania (TiO2), ferrite (Fe2O3), chromium oxide (Cr2O3), silica (SiO2), yttria (Y2O3), and magnesia (MgO) to generate far infrared rays.

7. The steam generator according to claim 2, where the powder mixture is one or more materials selected from the group consisting of alumina (Al2O3), titania (TiO2), ferrite (Fe2O3), chromium oxide (Cr2O3), silica (SiO2), yttria (Y2O3), and magnesia (MgO) to generate far infrared rays.

8. The steam generator according to claim 1, where the electromagnetic waves are between 4 μm to 14 μm.

9. The steam generator according to claim 1, where the layer of powder mixture is multi-element mineral powder including anhydrous silicon (SiO2), aluminum oxide (Al2O3), iron oxide (Fe2O3), magnesium oxide (MgO), calcium oxide (CaO), anhydrous silicon (SiO2), manganese oxide (MnO), and anhydrous phosphoric acid (P2O5).

10. The steam generator according to claim 1, where the heating device is an electric heater.

11. The steam generator according to claim 1, where the heating device is a high- voltage discharge unit for atomizing steam provided through the steam passage.

12. The steam generator according to claim 1, further including a lid member releasably coupled to the water storage container to refill the water storage container with water.

13. A steam generator comprising:
a water storage container having a layer of powder mixture capable of negatively ionizing the water stored in the water storage container;
a heating device adapted to heat the water stored in the water storage container to generate ionized steam; and
a nozzle adapted to release the ionized steam from the water storage container to a user's face.

14. The steam generator according to claim 13, where the layer of powder mixture further emits far infrared rays.

15. The steam generator according to claim 14, where the powder mixture includes a mixture of alumina (Al2O3), titania (TiO2), ferrite (Fe2O3), chromium oxide (Cr2O3), silica (SiO2), yttria (Y2O3), and magnesia (MgO) to generate far infrared rays.

16. The steam generator according to claim 14, where the powder mixture is one or more materials selected from the group consisting of alumina (Al2O3), titania (TiO2), ferrite (Fe2O3), chromium oxide (Cr2O3), silica (SiO2), yttria (Y2O3), and magnesia (MgO) to generate far infrared rays.

17. The steam generator according to claim 13, where the negatively ionized steam emits electromagnetic waves between 4 and 14 μm.

18. The steam generator according to claim 13, where the layer of powder mixture includes multi-element minerals including anhydrous silicon (SiO2), aluminum oxide (Al2O3), iron oxide (Fe2O3), magnesium oxide (MgO), calcium oxide (CaO), anhydrous silicon (SiO2), manganese oxide (MnO), and anhydrous phosphoric acid (P2O5).

19. The steam generator according to claim 13, further including a steam passage between the water storage container and the nozzle.

20. A method of moisturizing facial skin, comprising:
heating water to generate steam;
negatively ionizing the steam; and
delivering the negatively ionized steam to facial skin.

21. The method of claim 20, further including incorporating far infrared rays to the negatively ionized steam.

22. The method of claim 20, further including providing a mixture of multi-element powder along the path of the steam to negatively ionize the steam.

23. The method of claim 22, where the mixture of multi-element powder generates electromagnetic waves between 4 μm and 14 μm.

24. The method of claim 22, where a layer of powder mixture is provided along the path of the passing of the steam to generate far infrared rays, the layer of powder mixture includes one or more materials selected from the group consisting of alumina (Al₂O₃), titania (TiO2), ferrite (Fe2O3), chromium oxide (Cr2O3), silica (SiO2), yttria (Y2O3), and magnesia (MgO).

25. The method of claim 22, further including: mixing multi-element powder with water; spraying the powder mixture in the path; and drying the mixture to provide the multi-element powder on the path.

26. A steam generator comprising:
means for generating steam through a nozzle; and
means for negatively ionizing the steam.

27. The steam generator according to claim 26, further including means for incorporating far infrared rays in the steam.

28. The steam generator according to claim 26, where the means for generating steam includes: a water storage container; and a heating device adapted to heat water stored in the water storage container to generate steam, where the water storage container is coupled to the nozzle to release the steam therethrough.

29. The steam generator according to claim 28, where the means for negatively ionizing the steam is a layer of powder mixture capable of emitting electromagnetic waves provided within an inner surface of the water storage container.

30. The steam generator according to claim 29, where the layer of powder mixture includes one or more materials selected from the group consisting of alumina (Al₂O₃), titania (TiO2), ferrite (Fe2O3), chromium oxide (Qr2O3), silica (SiO2), yttria (Y2O3), and magnesia (MgO) to generate far infrared rays.

31. The steam generator according to claim 26, where the means for ionizing the steam emits electromagnetic waves between 4 μm and 14 μm.

32. The steam generator according to claim 29, where the layer of powder mixture is multi-element mineral powder including anhydrous silicon (SiO2), aluminum oxide (Al2O3), iron oxide (Fe2O3), magnesium oxide (MgO), calcium oxide (CaO), anhydrous silicon (SiO2), manganese oxide (MnO), and anhydrous phosphoric acid (P2O5).

33. The steam generator according to claim 28, where the heating device is an electric heater.

34. The steam generator according to claim 28, where the heating device is a high- voltage discharge unit for atomizing steam provided through the steam passage.

35. The steam generator according to claim 1, further including a lid member releasably coupled to the water storage container to refill the water storage container with water.
